(19) United States
(12) Patent Application Publication
(10) Pub. No.: US 2014/0281689 A1
(43) Pub. Date: Sep. 18, 2014

(54) METHOD AND SYSTEM FOR REBUILDING DATA FOLLOWING A DISK FAILURE WITHIN A RAID STORAGE SYSTEM

(71) Applicant: Teradata Corporation., Dayton, OH (US)

(72) Inventor: Matthew James Fischer, Escondido, CA (US)

(73) Assignee: Teradata Corporation, Dayton, OH (US)

(21) Appl. No.: 14/097,290

(22) Filed: Dec. 5, 2013

Related U.S. Application Data
(60) Provisional application No. 61/801,108, filed on Mar. 15, 2013.

(51) Int. Cl. G06F 11/20

(52) U.S. Cl. CPC G06F 11/2053
USPC 714/6.22

(57) ABSTRACT

A method and system for rebuilding data following a disk failure within a RAID storage system. The rebuild process keeps track of the relative number of READ operations across a RAID group so that following a RAID disk failure, the most frequently read areas of the RAID group can be rebuilt before less frequently accessed areas. Host READs to the rebuilt area will no longer necessitate on-the-fly rebuild from parity data, and thus host performance will be much less impacted than with prior rebuild processes.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/801,108, entitled “METHOD AND SYSTEM FOR REBUILDING DATA FOLLOWING A DISK FAILURE WITHIN A RAID STORAGE SYSTEM,” filed on Mar. 15, 2013, by Matthew Fischer.

### FIELD OF THE INVENTION

The present invention relates to disk array storage devices for computer systems and, more particularly, to an improved method for rebuilding data following a disk failure within a RAID storage system.

### BACKGROUND OF THE INVENTION

A disk array or RAID (Redundant Array of Inexpensive Disks) storage system comprises two or more computer system hard disk drives or solid state drives. Several disk array design alternatives were first described in an article titled “A Case for Redundant Arrays of Inexpensive Disks (RAID)” by David A. Patterson, Garth Gibson and Randy H. Katz; University of California Report No. UCB/CSD 87/391, December 1987. This article discusses disk arrays and the improvements in performance, reliability, power consumption and scalability that disk arrays provide in comparison to single large magnetic disks. Five disk array arrangements, referred to as RAID levels, are described. The simplest array, a RAID level 1 system, comprises one or more disks for storing data and an equal number of additional “mirror” disks for storing copies of the information written to the data disks. The remaining RAID levels, identified as RAID level 2, 3, 4 and 5 systems, segment the data into portions for storage across several data disks. One or more additional disks are utilized to store error check or parity information.

In 1993, these RAID levels were formalized in the first edition of the RAIDBook, published by the RAID Advisory Board, an association of manufacturers and consumers of disk array storage systems. In addition to the five RAID levels described by Patterson et al., the RAID Advisory Board now recognizes four additional RAID levels, including RAID level 0, RAID level 6, RAID level 10 and RAID level 53. RAID level 3, 5, and 6 disk array systems are illustrated in FIGS. 1 through 3, respectively.

In order to coordinate the operation of the multitude of disk or tape drives within an array to perform read and write functions, parity generation and checking, and data restoration and reconstruction, complex storage management techniques are required. Array operation can be managed through software routines executed by the host computer system or by a dedicated hardware controller constructed to control array operations.

RAID level 2 and 3 disk arrays are known as parallel access arrays.

Parallel access arrays require that all member disks (data and parity disks) be accessed, and in particular, written, concurrently to execute an I/O request. RAID level 4 and 5 disk arrays are known as independent access arrays. Independent access arrays do not require that all member disks be accessed concurrently in the execution of a single I/O request. Operations on member disks are carefully ordered and placed into queues for the member drives.

RAID level 2, 3, and 4 disk arrays include one or more drives dedicated to the storage of parity or error correction information. Referring to FIG. 1, a RAID level 3 system including a disk array 103 comprising three data drives, Disk 0 through Disk 2, and a parity disk drive, Disk 3, is illustrated. An array controller, not shown, coordinates the transfer of data between a host system 101 and the disk array 103. The controller also calculates and checks parity information. Data blocks A1-A3, B1-B3, C1-C3, and D1-D3 and parity blocks Ap, Bp, Cp, and Dp illustrate the manner in which data and parity is stored on the four array drives.

RAID level 5 disk arrays are similar to RAID level 4 systems except that parity information, in addition to the data, is distributed across the N+1 disks in each group. Each one of the N+1 disks within the array includes some blocks for storing data and some blocks for storing parity information. Where parity information is stored is controlled by an algorithm implemented by the user. As in RAID level 4 systems, RAID level 5 writes typically require access to two disks; however, no longer does every write to the array require access to the same dedicated parity disk, as in RAID level 4 systems. This feature provides the opportunity to perform concurrent write operations. Referring to FIG. 2, a RAID level 5 system including a disk array 105 comprising four data and parity disk drives, Disk 0 through Disk 3 is illustrated. An array controller, not shown, coordinates the transfer of data between a host system 101 and the array disk drives. The controller also calculates and checks parity information. Data blocks A1-A3, B1-B3, C1-C3, and D1-D3 and parity blocks Ap, Bp, Cp, and Dp illustrate the manner in which data and parity is stored on the four array drives.

The relationship between the parity and data blocks in the RAID level 5 system illustrated in FIG. 2 is as follows:

PARITY Ap=(BLOCK A1)⊕(BLOCK A2)⊕(BLOCK A3)

PARITY Bp=(BLOCK B1)⊕(BLOCK B2)⊕(BLOCK B3)

PARITY Cp=(BLOCK C1)⊕(BLOCK C2)⊕(BLOCK C3)

PARITY Dp=(BLOCK D1)⊕(BLOCK D2)⊕(BLOCK D3)

As shown above, parity data can be calculated by performing a bit-wise exclusive-OR of corresponding portions of the data stored across the N data drives. Alternatively, because each parity bit is simply the exclusive-OR product of all the corresponding data bits from the data drives, new parity can be determined from the old data and the old parity as well as the new data in accordance with the following equation:

new parity=old data⊕new data⊕old parity.

RAID level 6 extends RAID level 5 by adding an additional parity block, using block-level striping with two parity blocks distributed across all member disks. Referring to FIG. 3, a RAID level 6 system including a disk array 106 comprising five data and parity disk drives, Disk 0 through Disk 4 is illustrated. An array controller, not shown, coordinates the transfer of data between a host system 101 and the array disk drives. The controller also calculates and checks parity information. Data blocks A1-A3, B1-B3, C1-C3, and D1-D3 and parity blocks Ap, Bp, Cp, Dp, Aq, Bq, Cq, and Dq illustrate the manner in which data and parity is stored on the five array drives.

Parity-based RAID systems, e.g., RAID 3, 5, and 6 systems, incur a substantial performance impact under READ-dominant workloads when the RAID group has a failed drive. When the RAID group is degraded in this manner, every host READ operation issued to the failed drive within the group must instead be serviced by reading from the remaining drive members in the group and then regenerating the “missing” data (on the failed drive) from parity.

The impact of these “on-the-fly” data-rebuild operations is proportional to the size of the RAID group. If the RAID group has N number of drives, the number of discrete READ operations to rebuild the missing data requested by the host is N−1. Likewise, the probability that a host READ to the RAID group will result in a costly on-the-fly rebuild operation is approximately 1/N, where N is the number of drives in the RAID group.

The table below demonstrates the theoretical performance impact of a READ workload to a RAID-6 group, assuming a probability of access previously described.

TABLE 1
RAID-6 Read Host Impact Example

| | | Drives | Failed | # of Host | Projected # of | READ | Relative Time |
|---|---|---|---|---|---|---|---|
| | RAID | Per | Drives in | Reads | Drive Reads | Ops per | to Complete |
| | Type | Group | Group | (example) | w/i Group | Drive | Host Work |
| Optimal | 6 | 6 | 0 | 100 | 100.00 | 16.67 | 1x |
| Case | | | | | | | |
| Degraded | 6 | 6 | 1 | 100 | 166.67 | 33.33 | 2x |
| Case | | | | | | | |
| Critical | 6 | 6 | 2 | 100 | 200.00 | 50.00 | 3x |
| Case | | | | | | | |

For many applications, the performance degradation levels summarized above are extremely impactful. It is therefore desirable for the storage array to perform a background RAID group rebuild to a “spare” drive as soon as possible. Not only does this action put the RAID group on a path to returning to an optimal state, but any host READs associated with rebuilt RAID stripes do not require “on-the-fly” data rebuild operations to satisfy the associated host IO. As a result, even though a RAID group is still “degraded” during the background rebuild, the performance degradation level actually experienced by the host is much lower for the JO workloads that are associated with “rebuilt” RAID stripes.

The problem with this conventional rebuild model is that full-capacity RAID rebuilds take a very long time to complete, on the order of several days for today's multi-TB drives, and current rebuild algorithms dictate a sequential rebuild of data from the lowest RAID group logical block address (LBA) to the last LBA of the group. If the host workload in question has a frequently accessed “working-set” with an associated LBA range that is logically “distant” from this rebuild process, it will take a very long time before the RAID stripes associated with the host workload are rebuilt via this background process. This relationship is illustrated in the Conventional Rebuild Model diagram of FIG. 4.

Referring to FIG. 4, a sequential rebuild of data from the lowest RAID group, LBA 0, to the last LBA of the group, LBA N, is illustrated. The conventional sequential rebuild process repairs all the contiguous stripes within the first X % of the RAID group capacity before the frequently accessed RAID stripes associated with the host workload, contained within the area identified as Y %, are rebuilt via the background rebuild process.

As discussed above, and shown in FIG. 4, the host will be severely impacted for the duration of time required to rebuild the first X % of the RAID group. During this time, 1/N percentage of total reads to the working set, Y % of the RAID group, will result in on-the-fly rebuild operations to service those host READs. After the working set is rebuilt, host READs to this area will no longer necessitate on-the-fly rebuild from parity, and thus host performance will be much less impacted than it was prior.

### BRIEF DESCRIPTION OF THE DRAWINGS

FIG. 1 is a block diagram representation of a computer system including a RAID level 3 disk array storage system including three disk drives for the storage of data and an additional disk drive for the storage of parity information in accordance with the prior art.

FIG. 2 is a block diagram representation of a computer system including a RAID level 5 disk array storage system including four disk drives for the storage of data and parity information in accordance with the prior art.

FIG. 3 is a block diagram representation of a computer system including a RAID level 6 disk array storage system including five disk drives for the storage of data and parity information in accordance with the prior art.

FIG. 4 illustrates a conventional rebuild model for performing a background RAID group rebuild to a “spare” drive following a RAID drive failure.

FIG. 5 is a flow diagram illustrating a READ-frequency based rebuild process in accordance with the present invention.

FIG. 6 illustrates the creation of a “heat map” identifying the regions of highest read activities within a RAID group.

FIG. 7 illustrates the creation of an optimized RAID section rebuild sequence when performing a RAID group rebuild.

### DETAILED DESCRIPTION OF THE INVENTION

The solution described herein details a new rebuild algorithm that will greatly reduce the period under which HOST READs are impacted by “on-the-fly” data-rebuild operations, and therefore reduce the period under which host performance is heavily degraded.

To achieve this result, it is proposed that the RAID controller keep track of the relative number of READ operations across the RAID group such that the most frequently read areas of the RAID group can be rebuilt before less frequently accessed areas.

FIG. 5 illustrates how this READ-frequency based rebuild algorithm works:
1) The RAID controller logically divides the LBA range of the RAID group into S sections, as shown in step 510. Each section has an associated host READ counter that keeps track of the number of host MBs read over that section's LBA range.
2) Once an hour, the value of each section's READ MB counter is saved-off into a data-structure or other record-management facility, as shown in step 520.
3) The controller continues to save-off the READ MB counter values, for each section, once an hour, until it has is saved a maximum number of R records per section, where R is a user-defined attribute as shown in step 530. After R records have been obtained for a given section, subsequent record retrieval results in the oldest record being purged. In this way, the system continuously maintains the most recent R number of records for each section.
4) As shown in step 540, should a drive in the RAID group fail, the controller will take the following actions just prior to initiating the background rebuild process. These actions would typically coincide with the replacement of the failed drive, or the availability of a hot-spare drive (step 540).
   a) The controller creates one last record (R₁) within each section for the number of host MB read within the current sample period. This last record effectively captures the READ MB for each section from the time of the last scheduled sample, up to the current (pre-rebuild-start) time.
   b) The controller uses the IO counter records to prioritize the “highest value” sections to rebuild first. This could be done in a variety of ways with varying levels of sophistication, depending on whether recent, or historical, data is favored to predict future behavior. A few basic prioritization methods are defined below:
      i) “Highest Total” Method:
         The controller subtotals the number of host MBs read for all R records, plus the last record (R_{I}), for each section. This can be represented as follows, where MB_Count is equal to the subtotal per section, MB_{RI} equals the number of MB read during record R_{I}, and MBᵢ, represents the MB read during each sample, from 1 to R.

$$MB\_Count = {MB}_{R I} + {\sum }_{i = 1}^{R} M {B}_{i}$$

ii) Total with “Weighted Recent” Method:
   The controller subtotals the number of host MBs read for all R+R_{I} records, but applies weights to the last R_{W} samples to more heavily favor recent activity than older activity. The “recent” R_{W} READ MB samples are thus multiplied by some a user-defined factor, referred to here as R_{F}.

MB_Count=R_{F}*(MB_{RI}+Σᵢ₌₁^{R}^{_{W}}MBᵢ)+Σ_{i=R}_{_{W+1}}^{R}MBᵢ

Both of the methods above provide the means to differentiate the relative number of MBs read (MB_Count) per section. Using either of these approaches, the controller can create an effective “heat map” for READ frequency as a function of LBA range—where “hot” is considered a region of high READ frequency, and “cold” is considered a region of low READ frequency. An illustration of this relationship is shown in FIG. 6. In this example, a logical representation of a RAID group having sixteen sections (S=16), identified as Section 0 through Section 15, is shown. The six “hottest” sections, in order of their relative MB_Count values, are sections 6, 5, 7, 11, 4, and 8. The hottest six sections are noted for the sake of brevity. In practice, all sections would be considered and compared via their associated MB_Count values.
5) Finally, as shown in step 550, with the MB_Count computed for each of the S sections, the RAID controller can create an optimized rebuild sequence by sorting the sections based on their MB_Count values, from highest MB read to lowest. The sorted list becomes the section rebuild order, as demonstrated via FIG. 7, wherein the sections shown in FIG. 6 have been reordered to rebuild the hottest sections 6, 5, 7, 11, 4, and 8 prior to the all others.

The order in which the sections are rebuilt is governed by how frequently those sections were previously read by the host (MB_Count values). By rebuilding the “hottest”, or most frequently read, sections first, the time that that host is significantly impacted during the rebuild process is limited to the time it takes to rebuild only those sections.

As with conventional rebuilds, the proposed rebuild algorithm will require a few safeguards to ensure the controller always completes its rebuild operations completely (even if interrupted):
The controller must keep track of the RAID group sections that have already completed a rebuild, the current section being actively rebuilt, and the sections that are in-queue for rebuild.
For the section being actively rebuilt, the controller must periodically log the last RAID stripe that was successfully rebuilt.

The above status attributes will allow the controller to complete the overall background rebuild process for the Active section, as well as the “in-queue” sections, following power-loss or other interruptions. Furthermore, this information will enable the controller to consider “rebuild-complete” sections as optimal, such that no burdensome “on-the-fly” data-rebuild operations are attempted for READ I/Os associated with the rebuilt sections of the LBA address range.

The Figures and description of the invention provided above reveal a novel system and method for rebuilding data following a disk failure within a RAID storage system. The rebuild process keeps track of the relative number of READ operations across a RAID group so that following a RAID disk failure, the most frequently read areas of the RAID group can be rebuilt before less frequently accessed areas. Host READs to the rebuilt area will no longer necessitate on-the-fly rebuild from parity, and thus host performance will be much less impacted than with prior rebuild processes. The degree to which this rebuild algorithm will reduce the period of host degradation is a function of several factors.
LBA Range—The algorithm provides the greatest benefit when the majority of host READs are associated with a localized subset of the total RAID group address space. Conversely, the algorithm provides the least benefit when the JO access is completely equal across the entire RAID group LBA range.
RAID Group Offset—From a purely comparative standpoint (relative to conventional rebuilds), the algorithm provides the greatest benefit when the host's “working set” is located in the middle or near the end of the RAID group's LBA range.
Workload Consistency—Since this algorithm uses historical data to create an optimized rebuild sequence, the greatest benefit will be achieved when the LBA range associated with the “working set” remains somewhat consistent. If the workload is completely random and presents no more bias to READ one region of the disk than another, the algorithm will not fare as well.

For applications that present a fairly consistent workload over modest percentage of the RAID group capacity that is “deep” within the RAID group's LBA address space, the benefit via this algorithm would be substantial.

Instructions of the various software routines discussed herein, are stored on one or more storage modules in the system shown in FIGS. 1 through 3 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for rebuilding data following a disk failure within a RAID storage system, wherein data is stored in a plurality of RAID sections distributed across a plurality of data storage devices, the method comprising the steps of:
maintaining, by a processor, a record of I/O activity to each one of said plurality of RAID sections within said RAID storage system;
following a failure of one of said plurality of data storage devices, creating, by said processor, from said record of I/O activity, an optimized rebuild sequence comprising an identification of RAID sections prioritized according to RAID section I/O activity; and
rebuilding, by said processor, the RAID sections residing on said failed data storage device to a replacement data storage device in accordance with said optimized rebuild sequence.

2. The computer-implemented method for rebuilding data following a disk failure within a RAID storage system in accordance with claim 1, wherein said RAID storage system comprises one of the following:
A RAID 3 storage system;
A RAID 5 storage system, and
A RAID 6 storage system.

3. The computer-implemented method for rebuilding data following a disk failure within a RAID storage system in accordance with claim 1, wherein said RAID sections comprise logical block addresses (LBAs).

4. The computer-implemented method for rebuilding data following a disk failure within a RAID storage system in accordance with claim 1, wherein said I/O activity comprises read operations.

5. The computer-implemented method for rebuilding data following a disk failure within a RAID storage system in accordance with claim 1, wherein said optimized rebuild sequence comprises an identification of RAID sections ordered by highest to lowest RAID section I/O activity.

6. The computer-implemented method for rebuilding data following a disk failure within a RAID storage system in accordance with claim 1, wherein:
said record of I/O activity to each one of said plurality of RAID sections includes a record of recent I/O activity to each one of said plurality of RAID sections; and
said optimized rebuild sequence comprises an identification of RAID sections prioritized according to RAID section I/O activity including application of a weighting factor to said recent RAID section I/O activity.

7. A computer system comprising:
a RAID storage system, wherein data is stored in a plurality of RAID sections distributed across a plurality of data storage devices; and
a processor for:
maintaining a record of I/O activity to each one of said plurality of RAID sections within said RAID storage system;
following a failure of one of said plurality of data storage devices, creating from said record of I/O activity, an optimized rebuild sequence comprising an identification of RAID sections prioritized according to RAID section I/O activity; and
rebuilding the RAID sections residing on said failed data storage device to a replacement data storage device in accordance with said optimized rebuild sequence.

8. The computer system in accordance with claim 7, wherein said RAID storage system comprises one of the following:
A RAID 3 storage system;
A RAID 5 storage system, and
A RAID 6 storage system.

9. The computer system in accordance with claim 7, wherein said RAID sections comprise logical block addresses (LBAs).

10. The computer system in accordance with claim 7, wherein said I/O activity comprises a read operation.

11. The computer system in accordance with claim 7, wherein said optimized rebuild sequence comprises an identification of RAID sections ordered by highest to lowest RAID section I/O activity.

12. The computer system in accordance with claim 7, wherein:
said record of I/O activity to each one of said plurality of RAID sections includes a record of recent I/O activity to each one of said plurality of RAID sections; and
said optimized rebuild sequence comprises an identification of RAID sections prioritized according to RAID section I/O activity including application of a weighting factor to said recent RAID section I/O activity.

13. A non-transitory computer-readable medium having a computer program for rebuilding data following a disk failure within a RAID storage system, wherein data is stored in a plurality of RAID sections distributed across a plurality of data storage devices, the computer program including executable instructions that cause a processor to:
maintain a record of I/O activity to each one of said plurality of RAID sections within said RAID storage system;
following a failure of one of said plurality of data storage devices, create from said record of I/O activity, an optimized rebuild sequence comprising an identification of RAID sections prioritized according to RAID section I/O activity; and
rebuild the RAID sections residing on said failed data storage device to a replacement data storage device in accordance with said optimized rebuild sequence.

14. The non-transitory computer-readable medium having a computer program for rebuilding data following a disk failure within a RAID storage system in accordance with claim 13, wherein said RAID storage system comprises one of the following:
A RAID 3 storage system;
A RAID 5 storage system, and
A RAID 6 storage system.

15. The non-transitory computer-readable medium having a computer program for rebuilding data following a disk failure within a RAID storage system in accordance with claim 13, wherein said RAID sections comprise logical block addresses (LBAs).

16. The non-transitory computer-readable medium having a computer program for rebuilding data following a disk failure within a RAID storage system in accordance with claim 13, wherein said I/O activity comprises a read operation.

17. The non-transitory computer-readable medium having a computer program for rebuilding data following a disk failure within a RAID storage system in accordance with claim 13, wherein said optimized rebuild sequence comprises an identification of RAID sections ordered by highest to lowest RAID section I/O activity.

18. The non-transitory computer-readable medium having a computer program for rebuilding data following a disk failure within a RAID storage system in accordance with claim 13, wherein:
said record of I/O activity to each one of said plurality of RAID sections includes a record of recent I/O activity to each one of said plurality of RAID sections; and
said optimized rebuild sequence comprises an identification of RAID sections prioritized according to RAID section I/O activity including application of a weighting factor to said recent RAID section I/O activity.
